(19) United States
(12) Patent Application Publication
(10) Pub. No.: US 2013/0140120 A1
(43) Pub. Date: Jun. 6, 2013

(54) LUGGAGE SYSTEM WITH INTERCHANGEABLE COMPONENTS

(71) Applicant: Sheila RASMUSSEN, Grafton, WI (US)

(72) Inventor: Sheila RASMUSSEN, Grafton, WI (US)

(21) Appl. No.: 13/308,852

(22) Filed: Dec. 1, 2011

(51) Int. Cl. A45C 3/00; B23P 17/04

(52) U.S. Cl. 190/109; 29/428

(57) ABSTRACT

A luggage system is disclosed comprising a plurality of interchangeable components. Each component has at least one perimeter attachment means which is mateable with a counterpart perimeter attachment means on an adjacent component, thereby making the various components releasably attachable and completely detachable. The possible components of the luggage system may be a luggage case, a spacing member, an enclosure piece, and/or carrying means to allow a traveler to build a variety of luggage pieces that suit the particular packing, organizing, and transporting needs of the traveler.

### BACKGROUND OF THE INVENTION

Luggage and baggage systems have long been known and widely used by travelers. Historically, heavy trunks or chests composed of heavy materials have been used. Since the mid-twentieth century, lighter and more portable luggage has been used due to an increase in travelling, and especially, travelling by air. For air travel, passengers must adhere to airline standards when selecting luggage (i.e. size and weight limitations) which has resulted in the creation of many types and designs of luggage. Due to these restrictions, travelers must strategically select luggage that provides the space and organization necessary to their packing needs, but is also convenient to carry and use. This need has led to the creation of compartmental luggage and detachable components which assists in organization and provides convenience during transport. Though these designs have achieved considerable popularity and commercial success, there has been a continuing need for improvement. In particular, there remains a need for luggage that is compartmentalized to allow separation and organization of packed materials, such as separating clothing for each day of a trip, and/or has a plurality of interchangeable and/or cooperating pieces which allow for variations in size and/or alternative carrying options.

### SUMMARY OF THE INVENTION

A luggage system according to the present invention provides a single system of luggage that accommodates a variety of packing, travelling, and organizing needs of the traveler. First, it provides compartmentalization which helps a traveler to organize packed items. In addition, a luggage piece may be made as large or as small as desired for a particular trip, or for a particular day. For example, the traveler may not want to pack a separate backpack in the suitcase for a day trip, because the same components used to make the suitcase may be made into a backpack for the day trip. The luggage system also provides for a variety of carrying and transporting configurations, making the luggage piece easy to carry and/or to attach to a movable item such as a luggage cart, a bicycle, a motor vehicle, etc.

The luggage system according to the present invention provides a plurality of interchangeable components that can be attached to one another in a variety of configurations and preferably completely removable from one another when a certain component is not desired. Each of the components may be similarly sized and each may have at least one perimeter attachment means that is dimensioned according to a size and configuration of a counterpart perimeter attachment means on a second component of the luggage system, thereby allowing for attaching and detaching the various components to one another. The possible components of a luggage system according to the present invention may be a luggage case, an enclosure piece, a spacing member, and/or carrying means. A luggage system according to the present invention further preferably provides for attachment elements that may be coupled to components which are configured for receiving carrying means, such as straps, or for connecting other items to the piece of luggage. A luggage system according to the present invention may also provide a variable size connector which has a perimeter attachment means consistent with the size and shape of one component and a second perimeter attachment means of a different configuration to releasably attach together two components of different sizes and/or shapes. The invention further includes a method of using the luggage system for building various pieces of luggage.

### BRIEF DESCRIPTION OF THE DRAWINGS

FIG. 1 is a perspective view of a luggage piece constructed with components of a luggage system according to the present invention.

FIG. 2 is an exploded side view of a second luggage piece constructed with components of the luggage system according to the present invention.

FIG. 3A is a perspective view of a first embodiment of a variable size connector according to the present invention.

FIG. 3B is a perspective view of a second embodiment of a variable size connector according to the present invention.

FIG. 4A is a perspective view of a first embodiment of a luggage case according to the present invention.

FIG. 4B is a perspective view of a second embodiment of a luggage case according to the present invention.

FIG. 4C is a perspective view of a third embodiment of luggage case according to the present invention.

FIG. 5A is a perspective view of a first embodiment of an enclosure piece according to the present invention.

FIG. 5B is a perspective view of a second embodiment of an enclosure piece of the present invention.

FIG. 5C is a perspective view of a third embodiment of an enclosure piece of the present invention.

FIG. 5D is a perspective view of a fourth embodiment of an enclosure piece of the present invention.

FIG. 5E is a perspective view of a fifth embodiment of an enclosure piece of the present invention.

FIG. 6A is an elevation view of a sixth embodiment of an enclosure piece of the present invention.

FIG. 6B is an elevation view of the sixth embodiment of an enclosure piece shown in FIG. 6A in a partially closed position.

FIG. 7A is a perspective view of a seventh embodiment of an enclosure piece of the present invention.

FIG. 7B is a perspective view of an eighth embodiment of an enclosure piece of the present invention.

FIG. 8 is a perspective view of an alternative embodiment of a luggage case according to the present invention.

FIG. 9A is a perspective view of a first embodiment of a spacing member according to the present invention.

FIG. 9B is a perspective view of a second embodiment of a spacing member according to the present invention.

FIG. 10 is a perspective view of a third embodiment of a spacing member according to the present invention.

FIG. 11 is a side elevation view of the third embodiment of a spacing member of FIG. 10 opened into a flat arrangement.

FIG. 12 is a perspective view of a cart apparatus that may be used in connection with the luggage system of the present invention.

FIG. 13A is a perspective view of a reversible cart case according to the present invention in a first stowed position.

FIG. 13B is a side elevation view of the reversible cart case of FIG. 15A in a second position, wherein the cart elements are on the outside of the cart case.

FIG. 14 is a side elevation view of a third luggage piece constructed with components of a luggage system according to the present invention.

FIG. 15 is a side elevation view of a fourth luggage piece constructed with components of a luggage system according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

A luggage system of the present invention may be used to build various pieces of luggage. The luggage system comprises a plurality of interchangeable and cooperating segments used to build a piece of luggage suitable to a traveler's particular packing and carrying needs. The same plurality of segments can be used to create multiple configurations of luggage.

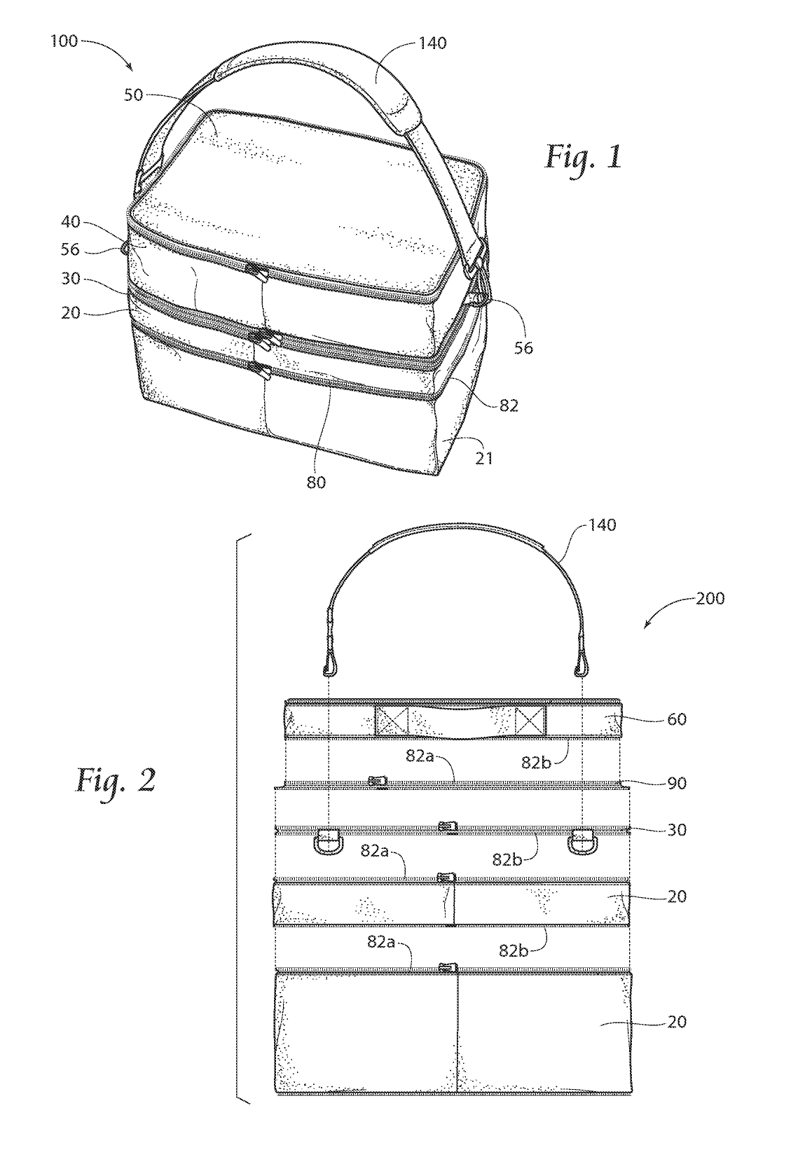

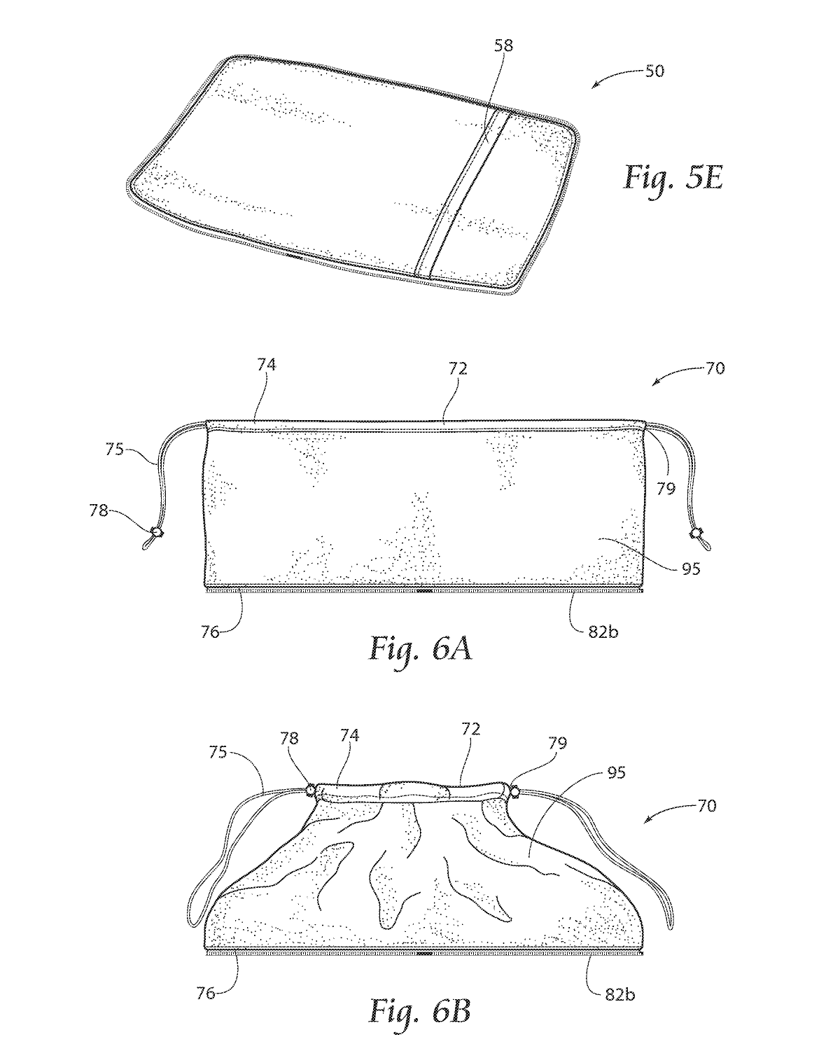

FIG. 1 shows one possible piece of luggage 100 built by a luggage system according to the present invention. As shown in FIG. 1 and an exploded view of a second possible piece of luggage 200 in FIG. 2, the luggage system according to the present invention may provide the following components: a luggage case 20, a spacing member such as an attachment belt 30 or an extension belt 40, and/or an enclosure piece such as a lid 50, a lid compartment 120 such as a laptop case 60, a cinch top 70 (shown in FIGS. 6A and 6B), or any other piece that provides enclosure of the space contained by any compartments. The luggage system may further comprise a carrying means such as a strap 140. Each of the components is connectable with at least one adjacent component, and is also preferably completely removable when not desired or needed. While any of these segments may be provided by the luggage system according to the present invention, not every piece is necessary in the system or in every configuration of luggage that is built by the traveler, and is still within the scope of this invention.

The various components of the luggage system are interconnectable and completely detachable via perimeter attachment means 80. The attachment means may comprise a zipper, a hook and loop fastener material around the perimeter, snaps, hooks, or any other attachment means by which one component is connectable to an adjacent component. In a preferred embodiment, the attachment means is a zipper 82. Generally, but with a few exceptions that will be discussed below, each component preferably has a first side zipper 82a and a second side zipper 82b, preferably of different polarities; one of either the first side zipper 82a or the second side zipper 82b being a male zipper portion and the other of either the first side zipper 82a or the second side zipper 82b a female zipper portion, as can be seen in FIG. 2. Each zipper portion 82a or 82b is configured to attach to its counterpart on an adjacent component, therefore each component in a luggage system may have, for example, a female zipper portion at the first side perimeter and a male zipper at the second side perimeter, as shown, such that the first side of one compartment may attach to a second side of the next compartment, and so on. A luggage system may be provided wherein the male and female zipper portions are reversed on each component. The same principles of associated attachment means (i.e. male and female counterparts) apply to the hook and loop fasteners, or any other attachment means that may be used, such that any component may be attached to any other component by the same means of attachment.

The components of the luggage system may be any size and shape that is appropriate for carrying and travel. In a preferred embodiment, the components are rectangular shaped with the rectangular base being sized in accordance with typical carry-on dimensions, 15″×9″.

Preferably, the components may have approximately the same dimensions, or have perimeter attachment means 80 of approximately the same dimensions, such that the perimeter attachment means 80 on adjacent components can be easily adjoined.

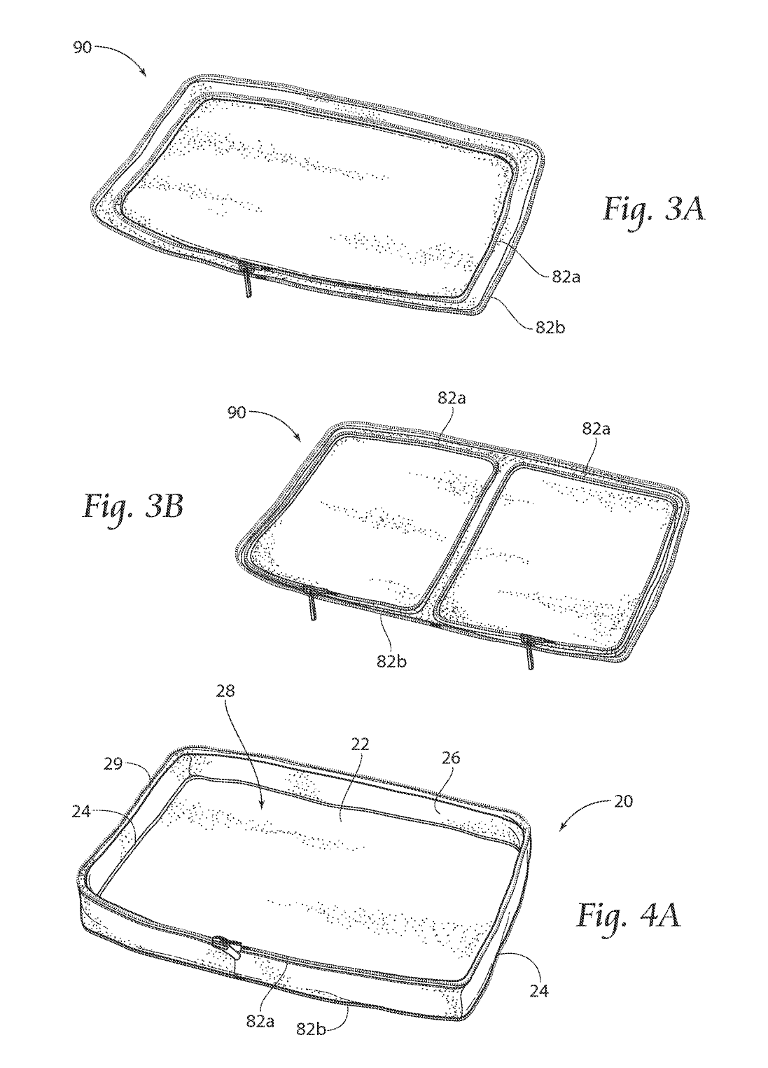

There may also be a need to attach together compartments of different sizes, that may be provided by the luggage system according to the present invention. There may be provided a smaller or differently shaped compartment that serves a different purpose, such as a wallet holder, a laptop case 60, a make-up case, or other smaller compartment. Therefore, the system may provide a variable size connector 90, shown in FIGS. 3A and 3B, which has a second side perimeter zipper 82b to attach to its counterpart on a component of a first size, and one or more first side zippers 82a forming one or more different sized perimeters to connect with one or more components of a different size or shape.

Alternatively, a variable size connector 90 may have a single first side perimeter zipper 82a to attach to its counterpart on a component of a first size, and one or more second side perimeter zippers 82b forming one or more different sized perimeters to connect with one or more components of a different size or shape.

A variable size connector 90 may also have more than one perimeter zippers 82a on a first side and more than one perimeter zippers 82b on a second side, thereby allowing at least two components to be attached to each side of the variable size connector 90.

### Luggage Case

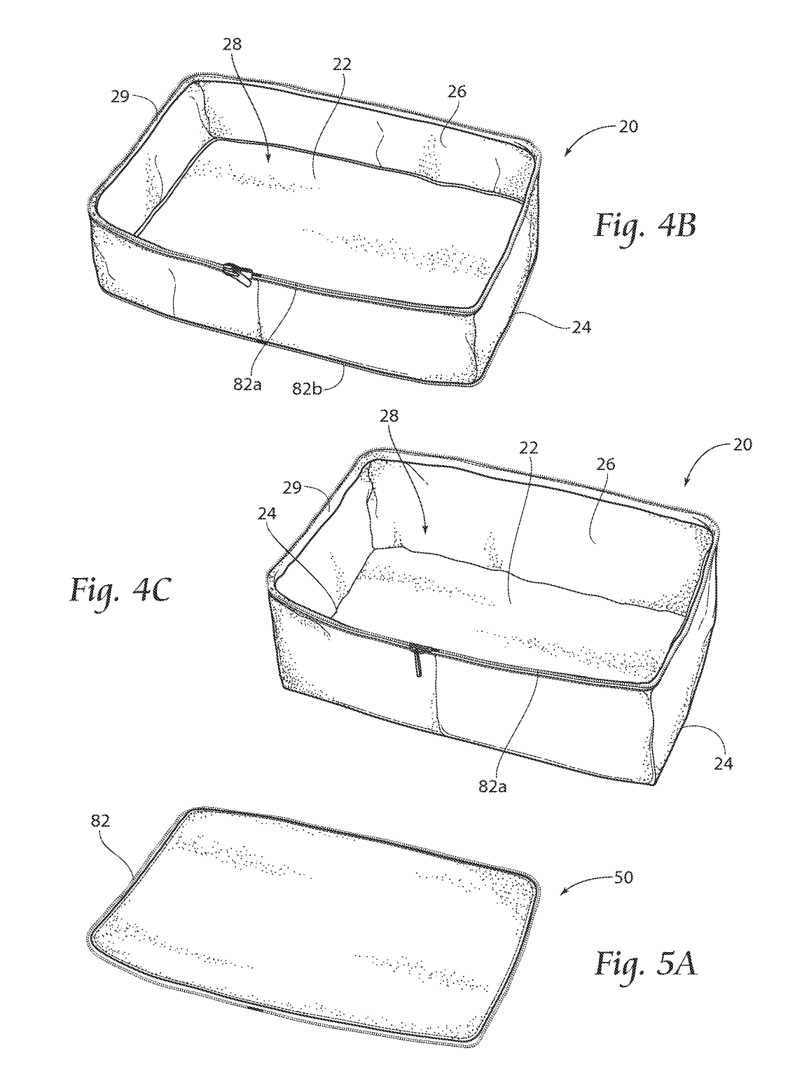

Looking to FIGS. 4A-4C, the luggage system may include a luggage case 20. A piece of luggage, such as that shown in FIG. 1, may comprise a plurality of interchangeable luggage cases 20, each having a different depth, or it may have a plurality of luggage cases 20 having the same depth, or any combination thereof. FIGS. 4A-4C show embodiments of a luggage case 20, each having a different case depth. The luggage case 20 may have a base panel 22, side walls 26 extending perpendicular from the base panel 22 at its perimeter 24, forming a case opening 28, an attachment means 80 such as a zipper 82a attached to the side walls 26 around the perimeter 29 of the case opening 28, and a second perimeter attachment means 80 such as a zipper 82b on the perimeter 24 of the base panel 22 on the outside of the side walls 26. The luggage case 20 may be attached to a second luggage case 20 or other component of the luggage system by way of the zippers 82a, 82b.

FIG. 4C shows an alternative type of luggage case 20, a base case 21. A base case 21 may be a luggage case 20 that is supplemented with a reinforced material in the side walls 26 and/or base panel 22 so as to form a more sturdy base for the piece of luggage. This base case 21 may also have only one zipper 82a at the perimeter 29 of the case opening 28 because its function as a luggage base may not require attachment to any other components on the base panel 22 side of the case 20.

A luggage case 20 may be the same size as the other components of the piece of luggage, or may be a different size or shape, and therefore may be connected to the other luggage components by the variable size connector 90 discussed above.

In an alternative embodiment, the luggage case 20 may be constructed of two separate components that are connectable and detachable via the perimeter attachment means 80. For example, the luggage system may provide a separate base panel 22 having at least one perimeter zipper 82 that is attachable to an extension belt 40 (shown in FIGS. 10-11) that forms the side walls 26 of the case 20. The extension belt 40 will be discussed further below.

### Enclosure Piece

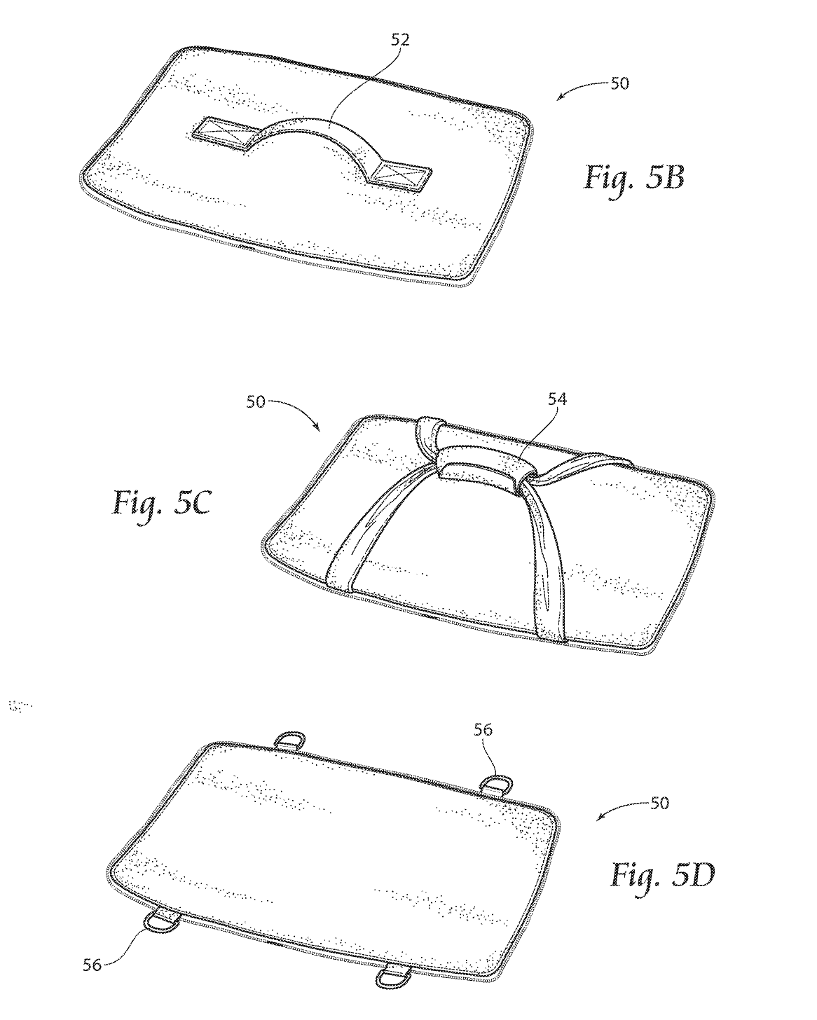

A luggage system according to the present invention may further include an enclosure piece which at least partially covers the case opening 28. One type of enclosure piece is a luggage lid 50, shown in FIG. 5A. The luggage lid 50 may be made of a single layer of material and a single perimeter zipper 82b. The luggage lid 50 may be sized to match the size of the adjacent luggage case 20, or other component. The luggage lid 50 may comprise additional features, such as carrying means, including, by way of example those shown in FIGS. 5B-5D: a carrying handle 52, hand straps 54, and/or perimeter D-rings 56 to which an external shoulder strap, hand strap, or other carrying means may attach. The lid 50 may also have additional features, such as a pocket 58 shown in FIG. 5E, a wallet (for holding money and/or business and credit cards) or another convenience feature attached directly to the luggage lid 50.

The lid 50 is not limited to an enclosure piece for the piece of luggage. Alternatively, the lid may be a lid connector that also has a first side perimeter zipper 82a so that it is connectable to a second component, thereby forming an enclosure of one component and being connectable to a second component.

The enclosure piece may also be a cinch top 70, as shown in FIGS. 6A and 6B. The cinch top 70 may have a cinching mechanism 72 at a first perimeter 74 and a perimeter zipper 82b at a second perimeter 76 to attach to an adjacent component, such as a luggage case or an extension member (discussed below). The cinching mechanism 72 may comprise rope or string 75, threaded through a channel 79 along the perimeter 74. The cinching mechanism 72 may also be securable in a cinched position via the securing member 78. The first perimeter 74 having the cinching mechanism 72 and the second perimeter 76 having the zipper 82b may be nearly adjacent or spaced at any distance, but in a preferred embodiment, having some luggage material 95 in between the cinch top 72 and the perimeter zipper 82b to allow for cinching without being impeded by the reduced flexibility of the zipper 82.

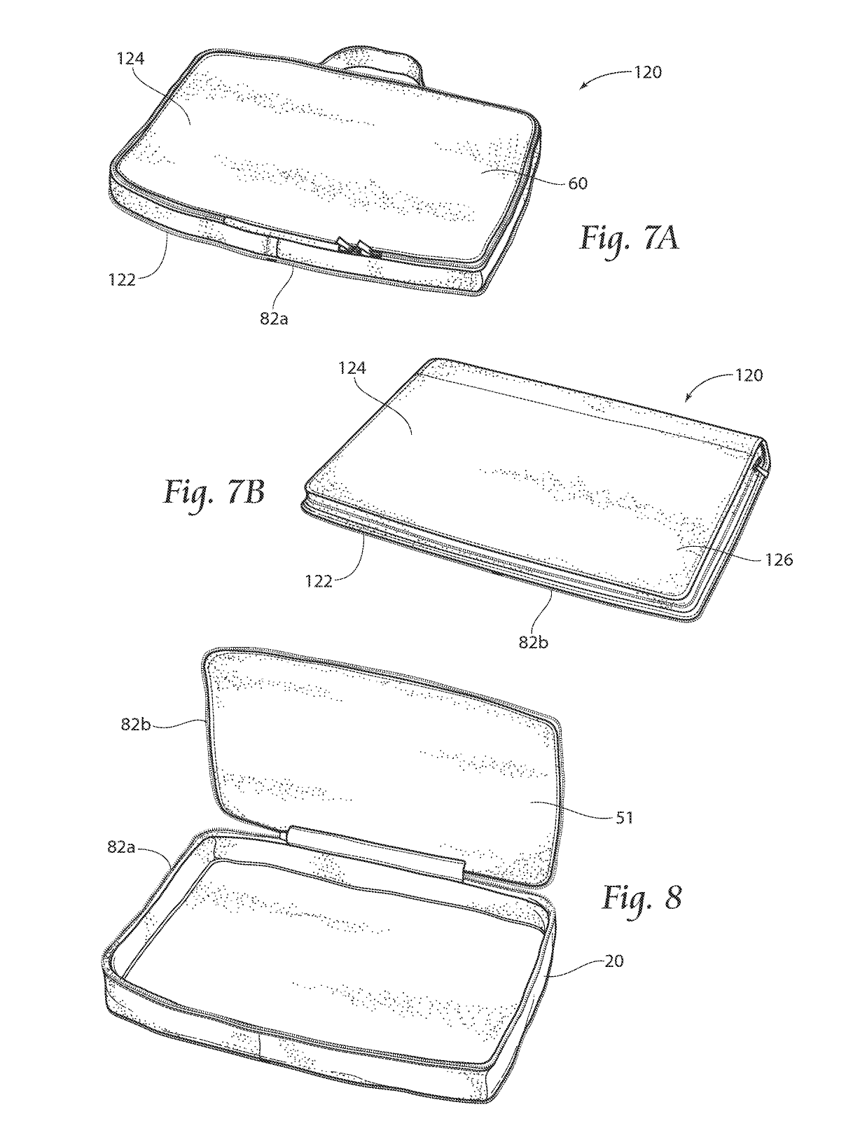

As shown in FIGS. 7A-7B, the enclosure piece may itself define a lid compartment 120 defined from at least two pieces of luggage material, one forming a base 122 of the compartment 120 and having a perimeter zipper 82b to attach to an adjoining component, and a second piece of material that is substantially and, preferably, releasably attachable to the first piece of material 120, forming a cover 124 for the compartment 120. The lid compartment 120 may be a substantially flat piece forming a folder 126 or envelope type enclosure lid. The lid compartment 120 might also be deeper to accommodate holding a computer or other electronic device, such as laptop case 60. The lid compartment 120 may be the same size as other components of the piece of luggage, or may be a different size or shape, and therefore may be connected to the other luggage compartments by a variable size connector 90 discussed above, which may also be a type of enclosure piece.

The lid compartment 120 is not limited to an enclosure piece, alternatively, it may also have a first side perimeter zipper 82a so that the compartment 120 is connectable to a second adjacent component, rather than being only usable as an enclosure to a piece of luggage.

The enclosure piece may be unitarily formed with any component by including a lid panel 51 or lid compartment 120 as part of the component, such as a luggage case 20 further comprising a lid panel 51 that is at least partially coupled to the side walls 26 of the case 20, as shown in FIG. 8, or a lid panel 51 that is at least partially attached to the first side perimeter 41 of an attachment belt 30 or extension belt 40, or any other component of the luggage system.

### Spacing Member

The luggage system may further include a spacing member which may comprise a pair of perimeter zippers 82a, 82b spaced apart at a spacing height 130, and no base panel 22. As such, the spacing member does not create any compartmental separation between components, merely adds space 130 between them.

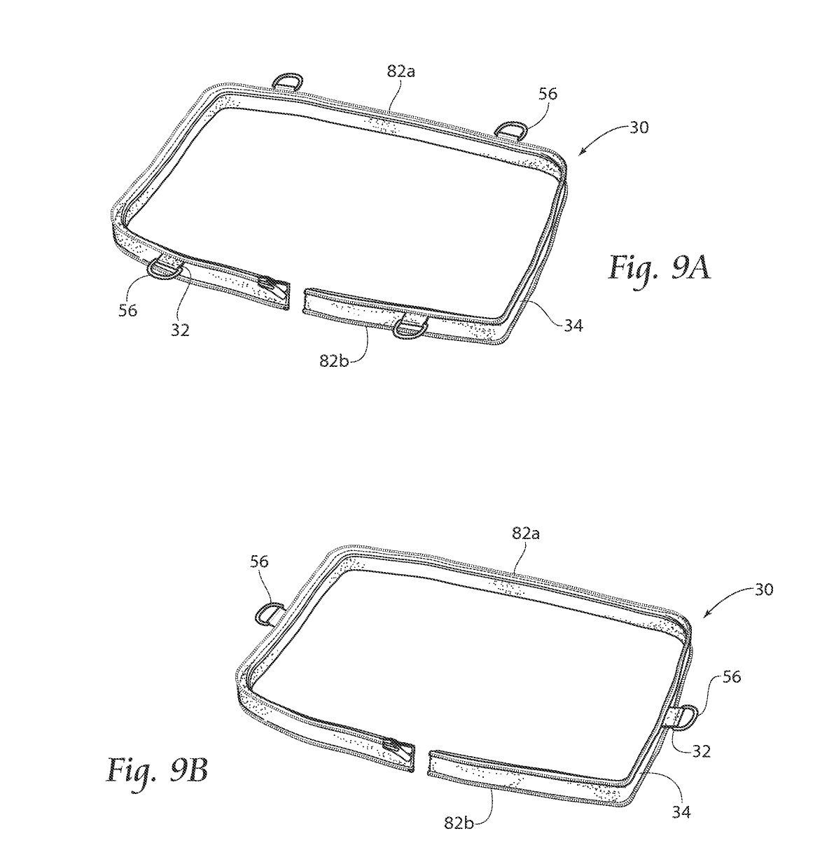

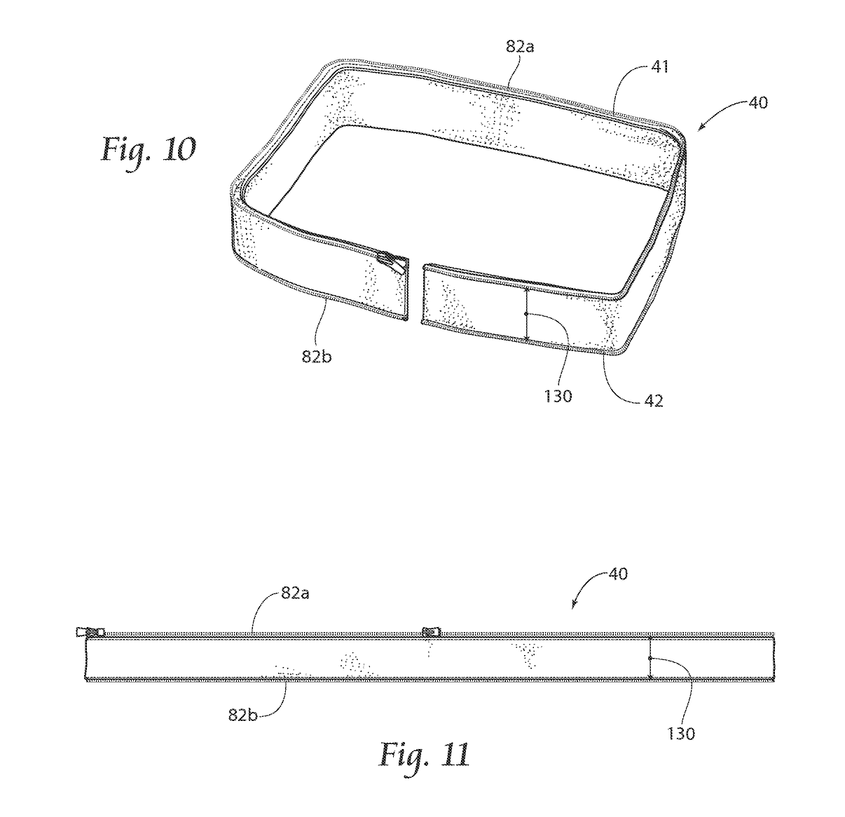

FIGS. 9A and 9B show one embodiment of a spacing member according to the present invention which may be an attachment belt 30 providing attachment elements 32 for attachment to straps 140 or other components for transporting, stowing, or for carrying other items. In a preferred embodiment, the attachment elements 32 of the attachment belt 30 may be a plurality of circumferentially spaced apart D-rings 56 which are configured to receive a luggage strap or other external attachable item, such as keys, small wallets, coin purses, sunglasses, etc. The D-rings 56 may be positioned at any location around the perimeter 34. In the embodiment shown in FIG. 9A, the D-rings 56 are positioned on the attachment belt 30 such that when adjoined to an adjacent component of the embodiments shown, the D-rings 56 are on a long side of the piece of luggage. In other embodiments, such as the embodiment shown in FIG. 9B, the D-rings 56 may be positioned on the attachment belt 30 such that the D-rings are located on a short side of the piece of luggage. Although combinations of two and four D-rings 56 are shown, any number of D-rings 56 may be used on an attachment belt 30.

The attachment belt may be configured at any spacing height 130, but in a preferred embodiment has a spacing height 130 that is substantially consistent with the height of two stacked zippers 82, such that the attachment belt 30 has minimal or no additional luggage material creating any space between the two zippers 82a, 82b.

Another embodiment of an attachment belt 30 may be a closed-loop belt wherein luggage material or other material spans the area defined by the starting end and the finishing end of each of the perimeter attachment means, or wherein the starting and finishing ends of the perimeter attachment means 82a, 82b are releasably or permanently attached by, for example, stitching, hook and loop fastener, or other mateable attachment mechanisms.

FIG. 10 and FIG. 11 show an extension belt 40. The extension belt 40 may be a spacing member having a selected height 130 of luggage material 95 disposed between a first perimeter 41 and a second perimeter 42 the perimeter zippers 82a, 82b to use as an extension to a luggage compartment 20 or to create a compartment. This feature may allow for a single luggage compartment 20 to be made into a case having a second depth. The extension belt 40 may be any desirable height 130, preferably ranging from approximately 1 inch to 6 inches. A luggage system of the present invention may provide a plurality of extension belts each having a different height 130 increased or decreased by at least 0.5 inch increments.

The extension belt 40 may also comprise attachment elements 32 such as D-rings 56.

Another embodiment of an extension belt 40 may be a closed-loop belt wherein luggage material or other material spans the area defined by the starting end and the finishing end of each of the perimeter attachment means, or wherein the starting and finishing ends of the perimeter attachment means 82a, 82b and the luggage material spanning between the perimeter attachment means 82a, 82b are releasably or permanently attached by, for example, stitching, hook and loop fastener, or other mateable attachment mechanisms.

### Carrying Options

A luggage system according to the present invention may accommodate a number of carrying variations. Various types of attachment elements 32 may be used with the components discussed above, not limited to the preferred D-rings 56. These attachment elements 32 may be configured to connect with a variety of carrying members or straps 140, or to connect to another item, such as, by way of example, another piece of luggage, a luggage cart, a bicycle frame, bicycle panniers, a canoe or kayak, a motor vehicle, etc. As shown in the Figures, the straps 140 that may be connectable to said attachment elements 32 may be backpack straps, shoulder straps, hand straps, or other connector straps, such as straps configured to connect to an external item, such as a bicycle or a luggage cart.

A variety of carrying options can be achieved by constructing a piece of luggage having the desired attachment elements 32 and selecting the desired carrying means or straps 140. A single piece of luggage may be carried in a plurality of ways by simply changing the configuration of a strap 140 or the type of carrying means used. As such, by way of example, a person may carry the same piece of luggage on his or her back for a period of time, and then may switch to carrying the luggage over his or her shoulder, merely by changing the configuration and/or type of straps 140 connected to the luggage.

The orientation of the straps 140 is also variable. For example, FIG. 1 shows a shoulder strap 140 connected across the length of the luggage piece 100. Alternatively, an attachment belt 30 of a different configuration, such as that shown in FIG. 2, may be used so that the shoulder strap is connectable across the width of the piece of luggage 100, either straight across or diagonally. The attachment belt 30 may also have attachment elements 32 on all sides of the perimeter, thereby allowing for a strap 140 to connect across the length or the width of the luggage piece, without changing the attachment belt 30.

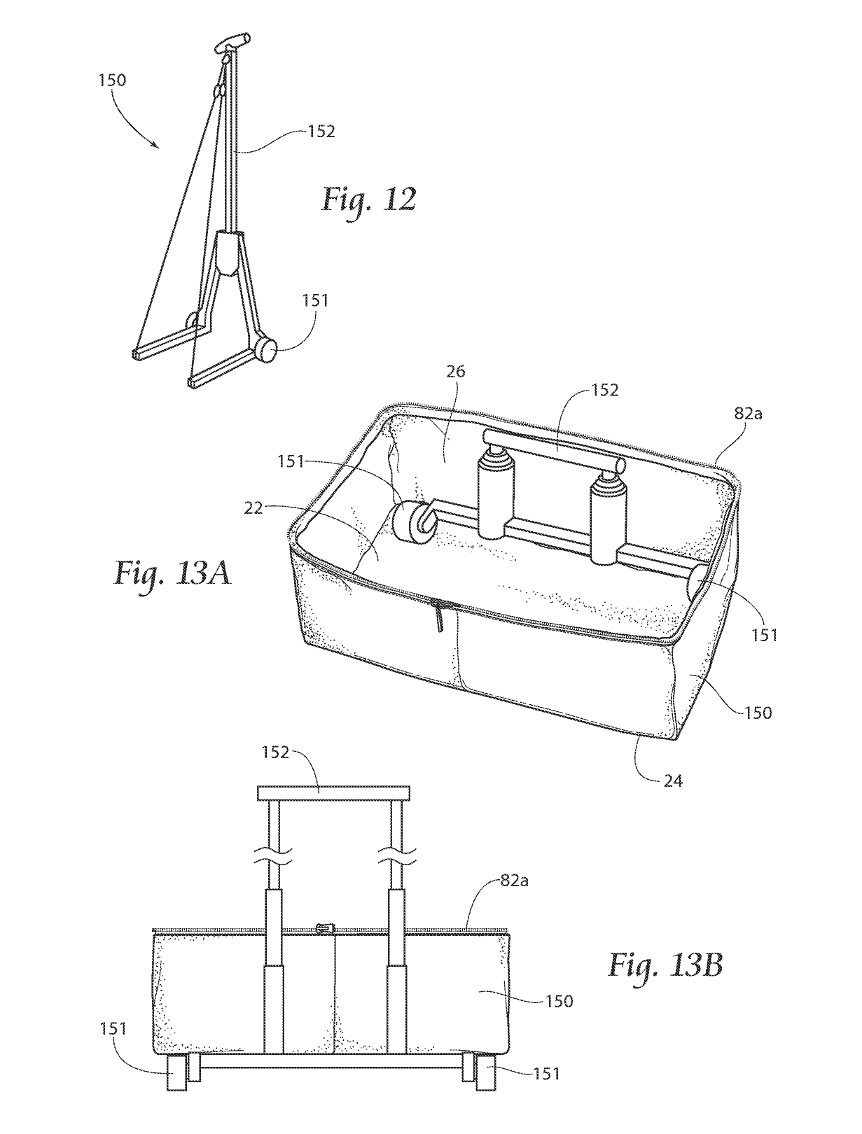

The luggage system may further include a cart apparatus, as shown in FIGS. 12 and 13, which may be used to transport the piece of luggage on at least one wheel 151. As shown in FIG. 12, a cart apparatus may be separate from the piece of luggage and may be used to carry the luggage thereon, or attachable to the piece of luggage, for example, by way of the attachment elements 32, straps 140, or any other means of connection between the piece of luggage and the separate cart apparatus. Alternatively, the cart apparatus may be incorporated into one of the components of the luggage system. In one embodiment, the components of a cart apparatus may be part of a case component, such as a luggage case 20, a luggage case 20 having no second side perimeter zipper 82b, or a base case 21, forming a cart case 150. As shown in FIGS. 13A-13B, in a preferred embodiment, the cart case 150 is preferably reversible, such that the components, such as the wheels 151 and the handle 152 may be enclosed on the inside of the piece of luggage in a stowed position when not needed, and may be exposed on the outside of the piece of luggage in a rolling position when rolling transport is desired. Such a configuration may require variations to the perimeter attachment means 80 or zipper 82. For example, the reversible case may require the use of at least two reversible perimeter zippers portions 82a, 82b, one on the perimeter of the cart case 150 and the reversible counterpart on a second compartment to which the cart case 150 will attach. Alternatively, the cart case 150 may have two first side perimeter zippers 82a in arranged in opposing directions, one for attachment when the cart case is in the stowed position of FIG. 13A, and the second zipper arranged for use when the cart case 150 is in the rolling position of FIG. 13B. Other variations to the perimeter attachment means 80 may be used to accommodate the reversible functionality of the cart case 150.

As shown in the figures, one or more wheels 151 may be coupled to either the base panel 22 or on the inside of a side wall 26 near the perimeter 24 of the base 22. While the embodiments shown comprise two wheels 151, any number of wheels 151 may be used to form a cart case 150. Preferably, the number of wheels 151 is between two and four. The side wall 26 may also have an extendable handle 152 apparatus coupled thereto, such as a telescoping handle that may be extended up from the cart case 150 for pulling by the traveler.

Alternatively, a cart apparatus may be coupled to a separate base panel 22, having no attached side walls 26, that is attachable to an adjacent component, such as an attachment belt 30, extension belt 40, or luggage case 20, via perimeter attachment means 80.

### Additional Component Options

Any of the components of the luggage system may further comprise carrying means, such as those discussed above in relation to the lid 50 and shown in FIGS. 5B-5D. For example, a luggage case 20, a spacing member, such as an attachment belt 30 or extension belt 40, variable size connector 90, lid compartment 120, or any other component of the luggage system according to the present invention may have carrying means such as a handle, hand straps, a loop, a shoulder strap, backpack straps or other means capable of use for carrying the luggage piece.

Any of the components of the luggage system may further comprise storage elements, such as a luggage case 20 further incorporating compression straps configured for securing items within the luggage case 20 in place. Other possible storage elements may be closeable compartments, pockets, straps, barriers forming compartments, or any other means of storing items that may be incorporated into any of the components of a luggage system according to the present invention.

In addition, the attachment elements are not limited to being positioned on an attachment belt 30 or extension belt 40 as discussed above. The attachment elements 32 may be positioned on any of the components of the luggage system, such as on an extension belt 40, around the perimeter of a luggage case 20, a lid 50 or lid connector, or on any variations of the components of the luggage system according to the present invention.

The components of the luggage system according to the present invention may be constructed of any suitable material having sufficient strength and durability for carrying packed items and for withstanding the general wear and tear associated with travel. Several luggage materials are contemplated for use with the luggage system, such as canvas, polyester, leather, and nylon, such as ballistic nylon, but any appropriate material may be used.

In addition, any of the components of the luggage system may be made of a rigid material or may have reinforcement material incorporated therein, such as plastic, metal, polypropylene or other rigid material to provide rigidity and strength to the components of the luggage system as well as to allow the component to retain its shape if subject to weight from packed items or other external forces that may be experienced during travel.

### Example Configurations

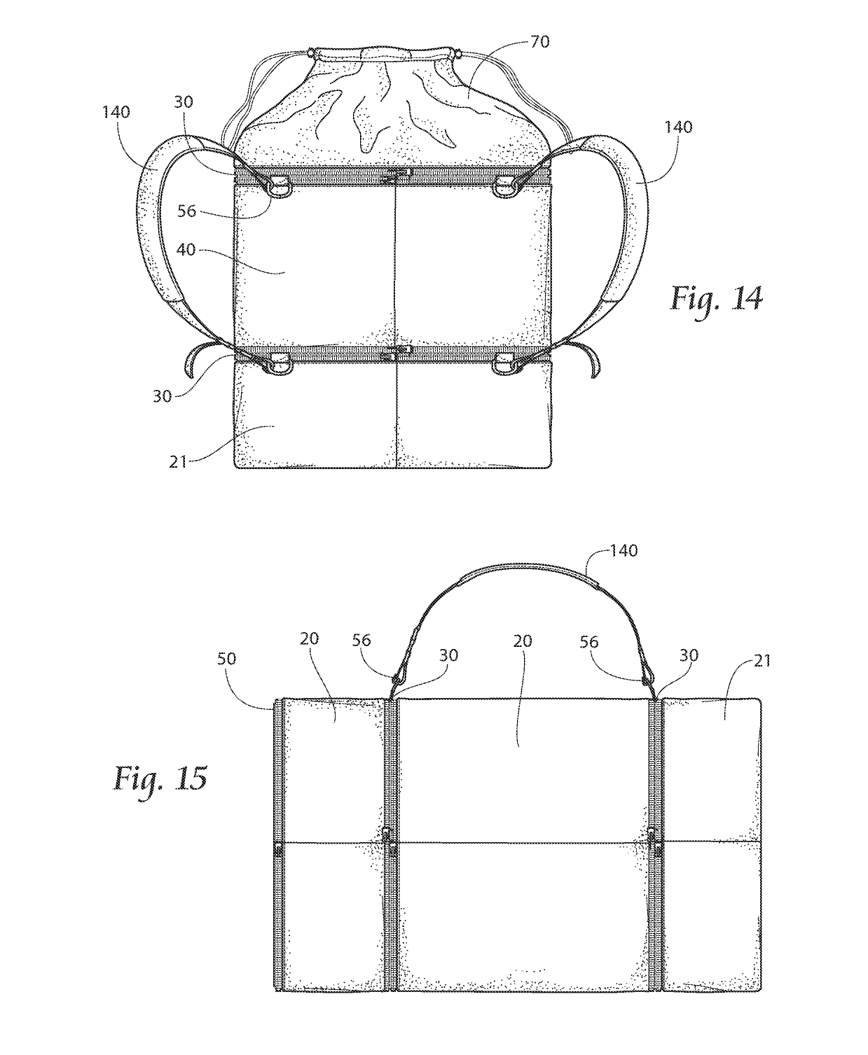

FIGS. 14 and 15 show two example configurations of luggage using components of the luggage system according to the present invention. These figures, along with FIGS. 1 and 2, merely represent some uses of the luggage system according to the present invention, including a cinching backpack, as shown in FIG. 14 and a duffle bag, as shown in FIG. 15. Each of these pieces can be constructed using the components according to the present invention, as well as a multitude of other configurations that allow for ease of carrying, organizing, and packing items for travel, based on the needs and convenience of the traveler.

The present invention also includes a method of using a luggage system comprising the steps of selecting a desired plurality of components provided by the luggage system and attaching said perimeter attachment means of a first of the components to its counterpart perimeter attachment means on a second component, and continuing the attachment of adjacent components via the perimeter attachment means to construct the desirable piece of luggage. The method may also include attaching carrying means to the piece of luggage for ease transport.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A luggage system for constructing a piece of luggage comprising:
a plurality of components forming at least one compartment, wherein a plurality of said components each comprise at least one perimeter attachment means, wherein said perimeter attachment means is equally dimensioned to a counterpart perimeter attachment means on an adjacent component, said perimeter attachment means allowing a first of at least one components to be releasably attachable to and completely removable from a second, adjacent component,
wherein said plurality of components comprise at least one luggage case, said luggage case comprising a base panel having a base perimeter and side walls extending from said base perimeter and forming a top perimeter surrounding a luggage opening, said top perimeter having said perimeter attachment means coupled thereto.

2. The luggage system according to claim 1 wherein said perimeter attachment means is a zipper.

3. The luggage system according to claim 1 wherein said luggage case further comprises a reinforcement material.

4. The luggage system according to claim 1 wherein at least one of said at least one luggage case further comprises a second perimeter attachment means coupled to said base perimeter for releasable attachment to said perimeter attachment means on an adjacent component.

5. The luggage system according to claim 1 wherein at least one of said at least one luggage case comprises at least one wheel.

6. The luggage system of claim 5 wherein said luggage case further comprises at least one handle mechanism coupled to and extending from said luggage case.

7. The luggage system according to claim 1 wherein at least one of said plurality of components is a spacing member, said spacing member having a first perimeter and a second perimeter separated at a spacing distance, said first perimeter and said second perimeter each having perimeter attachment means.

8. The luggage system according to claim 7 wherein said spacing member further comprises a plurality of spaced apart attachment elements.

9. The luggage system according to claim 8 wherein said spaced apart attachment elements are D-ring loops.

10. The luggage system according to claim 1 wherein at least one of said plurality of components is an enclosure piece configured to at least partially cover said luggage opening.

11. The luggage system according to claim 10 wherein said enclosure piece is a single layer of luggage material forming a lid.

12. The luggage system according to claim 11 wherein said lid further comprises a plurality of attachment elements spaced apart along said perimeter of said lid.

13. The luggage system according to claim 10 wherein said enclosure piece defines a lid compartment, having a base panel and a cover panel, said base panel covering said luggage opening and forming a base perimeter, said base perimeter having perimeter attachment means coupled thereto.

14. The luggage system according to claim 13 wherein said cover panel of said lid compartment further comprises a cover perimeter having said perimeter attachment means coupled thereto.

15. The luggage system according to claim 1 wherein at least one of said plurality of components is a variable size connector having at least one first perimeter attachment means of a first configuration, and at least one second perimeter attachment means of a second configuration.

16. The luggage system according to claim 1 wherein at least one of said plurality of components comprises a plurality of attachment elements.

17. The luggage system according to claim 16 further comprising carrying means connectable to at least one of said plurality of said attachment elements.

18. The luggage system according to claim 1 wherein at least one of said plurality of components comprises carrying means.

19. The luggage system according to claim 1 wherein at least one of said plurality of components comprises storage elements.

20. A method of constructing a piece of luggage comprising the steps of:
providing a luggage system comprising a plurality of components forming at least one compartment for storing items, wherein said components each comprise at least one perimeter attachment means, wherein said perimeter attachment means is equally dimensioned to a counterpart perimeter attachment means on an adjacent component, said perimeter attachment means allowing a first of at least one components to be releasably attachable to and completely removable from a second, adjacent component;
wherein said plurality of components comprises at least one luggage case, said luggage case comprising a base panel having a base perimeter and side walls extending from said base perimeter and forming a top perimeter surrounding a luggage opening, said top perimeter having perimeter attachment means coupled thereto;
selecting a plurality of said components to be used in forming said piece of luggage; and
attaching a first of said plurality of components to a second of said plurality of components by fastening said perimeter attachment means of said first component to its counterpart perimeter attachment means of said second components, forming a luggage piece.
